(19) United States
(12) Patent Application Publication
(10) Pub. No.: US 2007/0187869 A1
(43) Pub. Date: Aug. 16, 2007

(54) Single mold active speed sensor

(75) Inventors: John E. Bierslaker, Yorktown, VA (US); Michael Le-Bian, Newport News, VA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO Automotive Corporation, Auburn Hills, MI (US)

(21) Appl. No.: 11/355,268

(22) Filed: Feb. 15, 2006

(51) Int. Cl. B29C 45/14

(52) U.S. Cl. 264/265; 264/278

(57) ABSTRACT

A sensor assembly includes a Hall-effect sensor and an integrated circuit that are encapsulated with an encapsulating material. The Hall-effect sensor and integrated circuit are held in place during filling of the cavity by a retractable slide. Once the cavity is filled such that the encapsulating material can support the internal components in a desired position, the retractable slide is removed from the cavity. The encapsulating materials fill any voids created by the retractable slide to prevent the formation of additional openings within the completed encapsulated sensor assembly

### BACKGROUND OF THE INVENTION

This invention generally relates to a method of building a speed sensor assembly. More particularly, this invention relates to a method of overmolding a speed sensor assembly to minimize vulnerability to water intrusion.

A speed sensor is utilized to monitor the speed of a rotating element, such as a wheel or shaft. Speed sensors are necessarily mounted proximate the rotating element. In many applications, such as for monitoring wheel speed, the environment is particularly harsh for sensor components. Accordingly, conventional speed sensors are overmolded with plastic to protect the delicate circuits and sensor components from water and other debris.

Overmolding of the sensor assembly is accomplished by supporting the circuit and other components within a mold cavity by one or more support pins. The pins extend into the mold and into contact with the internal components of the sensor to hold those components firmly during the injection of plastic into the mold cavity. Once the injection molding process is complete the now overmolded part is removed.

Disadvantageously, holes are present within the completed part where the support pins were positioned. Such holes can provide a path for water to intrude into the sensor and affect the internal circuits and components. These holes can be plugged with some success through secondary molding or plugging operations, however, such operations add additional cost and provide only limited success and durability.

Accordingly, it is desirable to develop and design a method of producing an overmolded speed sensor with increased resistance to the intrusion of contaminants and moisture without introducing secondary operations.

### SUMMARY OF THE INVENTION

An example method of encapsulating a sensor assembly includes supporting an internal component with a retractable slide during filling of a mold cavity, and retracting the slides before encapsulation material cures to prevent the formation of openings by the retractable slides.

A sensor assembly includes a Hall-effect sensor and an integrated circuit that are encapsulated with an encapsulating material. The Hall-effect sensor and integrated circuit are held in place during filling of the cavity by a retractable slide. Once the cavity is filled such that the encapsulating material can support the internal components in a desired position, the retractable slide is removed from the cavity. The encapsulating materials fill any voids created by the retractable slide to prevent the formation of additional openings within the completed encapsulated sensor assembly.

Accordingly, the example method substantially eliminates moisture intrusion paths created during encapsulation of a sensor assembly.

These and other features of the present invention can be best understood from the following specification and drawings, the following of which is a brief description.

### BRIEF DESCRIPTION OF THE DRAWINGS

FIG. 1 is a schematic view of an example sensor assembly.

FIG. 2 is a schematic view of an initial stage of an example overmolding process according to this invention.

FIG. 3 is a schematic view of an intermediate stage of an example overmolding process according to this invention.

FIG. 4 is a schematic view of an almost completely filled cavity.

FIG. 5 is a schematic view of a filed cavity according to this invention.

### DETAILED DESCRIPTION OF THE PREFERRED EMBODIMENT

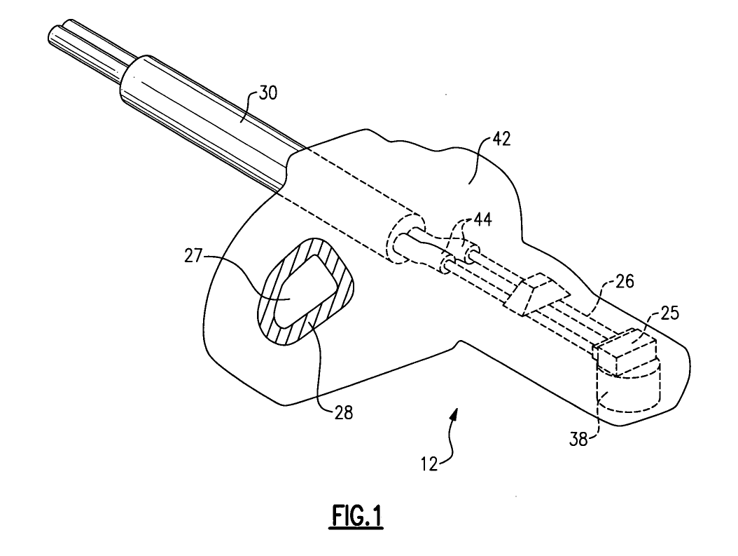

Referring to FIG. 1, a sensor assembly 12 includes a Hall-effect sensor 26 that is encapsulated within a plastic overmold 42. The Hall-effect sensor 26 is connected to leads 44 disposed within a cable sheath 30. The cable sheath 30 is partially encapsulated within the overmold 42 to prevent water intrusion. The speed sensor also includes an integrated circuit 25 connected to the Hall-effect sensor 26. The integrated circuit 25 extends over and adjacent a magnet 38 that is utilized for certain application specific requirements. The speed sensor includes an insert 28 that defines a mounting opening 27. As appreciated, the specific arrangement of the components within the speed sensor may be different than that illustrated to accommodate application specific requirements.

During operation, the speed sensor assembly 12 is typically exposed to moisture and other contaminants that can intrude into the encapsulated material and potential damage sensor components. Any passage or hole through the encapsulation provides a potential leak path for moisture to intrude into the speed sensor 12. The method of fabricating a speed sensor according to a disclosed example method reduces the number of openings formed within the encapsulation 42.

Referring to FIG. 2, a mold assembly 10 is schematically illustrated and includes a first mold half 14 and a second mold half 16 that define a cavity 18. The cavity 18 is formed to define the shape of the encapsulation 42 of the speed sensor assembly 12. The cable sheath 30 is supported between the first mold half 14 and the second mold half 16. The integrated circuit 25 is held in place by a slide assembly 34. The slide assembly 34 comprises two pins that extend from the mold assembly 10 into the cavity 18 to support the integrated circuit 25 during the molding process. The slide assembly 34 is moved between a support position that holds the integrated circuit 25 and a retracted position by an actuator 36. In the retracted position, the slide 34 is retracted into the mold assembly 10 and does not protrude into the cavity 18 or the encapsulation 42.

Encapsulation material is injected through an inlet 20 into the mold cavity 18. The encapsulation material is in a molten state and forms a flow front indicated at 24. The flow front of encapsulation material envelops the internal components of the speed sensor assembly 12.

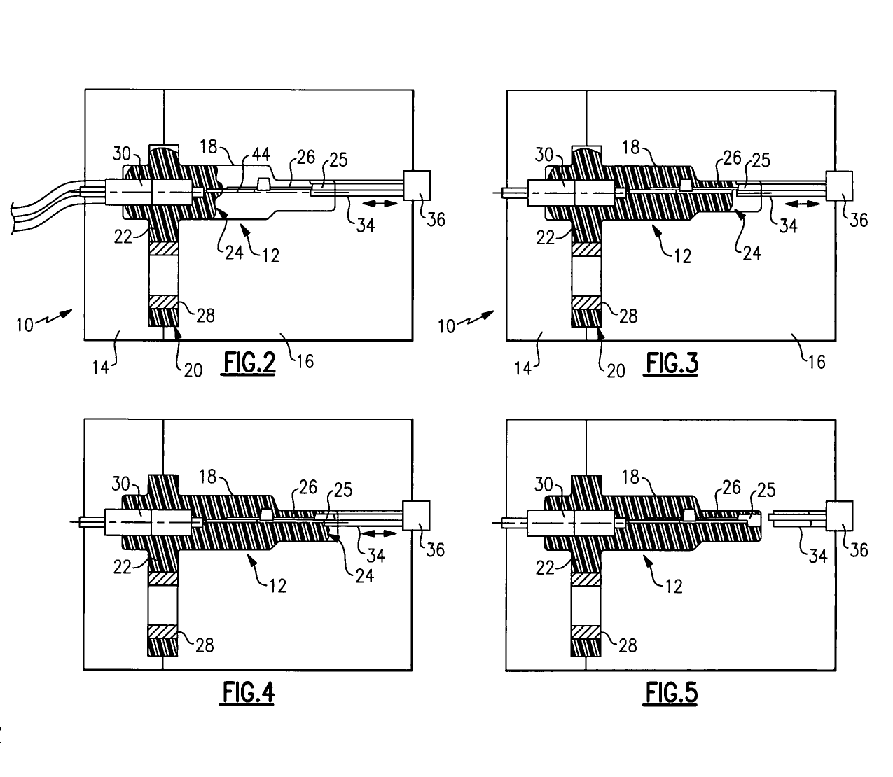

Referring to FIGS. 3 and 4, the flow front 24 moves outwardly from the inlet 20 to fill the cavity 18. The injection pressures utilized to drive molten encapsulated material into the mold cavity 18 require that the internal components be securely held during the filling phase of encapsulation. During the filling phase of the overmolding operation, internal components such as the Hall-effect sensor 26 and the integrated circuit 25 must be firmly held in place against the pressures generated by plastic filling the cavity 18. The slides 34 provide this holding function an in the illustrated example engage the integrated circuit 25 to maintain a desired position of all the internal components. However, the slides 34 may extend from other locations within the mold cavity 18 to engage and hold additional or other components during the overmolding process.

Referring to FIG. 5, once the cavity 18 is filled, the slides 34 are retracted to prevent the formation of additional openings within the encapsulation. The slides 34 are removed once the molten plastic cures sufficiently such that the flow front 25 stops moving and the molten plastic is of a consistency to support the internal components in the desired position.

The slides 34 are retracted at such a time determined to provide for the filling in of any voids that may have been formed by the slides 34 and still provide the desired support for the internal components of the speed sensor 12. The actuator 36 moves the slides 34 from the cavity 18, and is only one example of a method of retracting the slides from the mold cavity 18. The slides 34 may be retracted responsive to the plastic material pushing outwardly to fill the mold cavity 18. As the plastic material envelops the Hall-effect sensor 26 and the integrated circuit 25, the pins retract, leaving the partially cured plastic material to support the internal components.

The example method illustrated and described provides for the support of internal sensor assembly components during overmolding and reduces the number of potential leak paths by removing any support slide or pins at a desired time during the encapsulation filling process. The resulting sensor assembly includes only the leak paths created by components protruding from the encapsulation, such as the cable sheath 30. As should be appreciated, although a speed sensor is illustrated and described other overmolded sensor devices with other internal components would benefit from the disclosures of the example method.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A method of overmolding a sensor assembly comprising the steps of:
a) supporting a sensor component within a mold cavity with at least one slide member;
b) filling the mold cavity with settable material; and
c) removing the at least one slide member from the mold cavity once the settable material has filled the mold cavity and prior to curing of the molten plastic.

2. The method as recited in claim 1, wherein the at least one slide member does not displace settable material once removed from the mold cavity.

3. The method as recited in claim 1, including retracting the at least one slide member supporting the portion of the sensor component after filing of the mold cavity and before curing of the settable material.

4. The method as recited in claim 3, including the step of filling voids created by the at least one slide member before complete curing of the settable material.

5. The method as recited in claim 1, wherein the sensor assembly includes a cable and the mold includes an interface with the cable for sealing the mold cavity.

6. The method as recited in claim 5, including the step of forming an interface between the cable and the settable material by roughening the surface of the cable on surfaces in contact with the settable material.

7. A method of fabricating a sensor assembly comprising the steps of:
a) attaching electrical leads to a magnetic field sensor;
b) supporting the magnetic field sensor and electrical leads within a mold cavity with at least one retractable member;
c) filling the mold cavity with a settable material; and
d) retracting the at least one retractable member responsive to the settable material supporting the magnetic field sensor.

8. The method as recited in claim 7, including the step of filling voids created by the retractable member once the retractable member has been retracted from the position supporting the magnetic field sensor.

9. The method as recited in claim 7, wherein the electrical leads are supported within a sheath that extends outward of the mold cavity.

10. The method as recited in claim 9, including the step of preparing an outer surface of the sheath for sealing with the settable material.

11. The method as recited in claim 7, including the step of supporting a magnet within the mold cavity.

12. The method as recited in claim 7, wherein the magnetic field sensor comprises a Hall-effect sensor.
